(19) United States
(12) Patent Application Publication
(10) Pub. No.: US 2008/0068922 A1
(43) Pub. Date: Mar. 20, 2008

(54) Device for blending a binder component and a hardener component for producing a ready-made filler

(76) Inventor: Klaus-W. Voss, Ueterseu (DE)

Correspondence Address: Friedrich Kueffner;Suite 910, 317 Madison Avenue, New York, NY, 10017, US

(21) Appl. No.: 11/900,638

(22) Filed: Sep. 12, 2007

(30) Foreign Application Priority Data
Sep. 12, 2006 (DE) 20 2006 014 187.1
Feb. 22, 2007 (DE) 20 2007 002 792.3

(51) Int. Cl. B01F 15/02

(52) U.S. Cl. 366/134; 366/150.1; 366/307

(57) ABSTRACT

A device for blending at least two components into a mixed substance which has a simple construction and for which it is guaranteed that the containers of the components can be placed without mistake in the device, a mixing device (1) is provided inside which at least two components (A, b) are blended with each other, wherein the device has respectively one seat for one container (90, 91, 92) containing at least one component (A, B), wherein the seat has a surface, preferably in form of a carrying element (104) which has an opening (203) through which the component (A, B) can be delivered and at least one arrangement element (205, 208) is provided on the surface (104) for the guided setting and arrangement of the container (90, 91, 92) as a deepening and/or a recess and the carrying element (104) is carried out inclined with respect to the horizontal from its edge to a point which is situated on the carrying element (104), preferably to the center (204).

### BACKGROUND OF THE INVENTION

1. Field of the Invention

The present invention relates to a device for producing a ready-made filler for filling surfaces of, for example vehicle bodies, with a mixing device for blending at least two components, in particular a binder component and a hardener component to a pasty or liquid mixed substance, whereby the mixing device is provided with at least one inlet opening for supplying the binder component and at least one further inlet opening for supplying the hardener component, as well as with a delivery opening for delivering the mixed substance, whereby a mixing chamber is placed between the inlet openings and the delivery opening, mixing chamber inside which the at least two components are blended together, with respectively one seat for a container containing at least one component, whereby the seat has a surface, preferably in form of a carrying element, which has at least one opening through which the component can be spent out.

Moreover, the invention relates to a container for at least one component for producing a filler for filling surfaces with at least one basic surface and at least one lateral surface and a system from the device for producing a ready-made filling for filling surfaces and the container for at least one component for producing the filling mass. An auxiliary aspect of the invention is furthermore a device for blending at least two components, in particular a binder component and a hardener component to a pasty or liquid mixed substance.

2. Description of the Related Art

Such devices for blending at least two components are used for example for producing fillers, whereby a hardener component with a 1 . . . 2% fraction is added to a binder component in order to produce a hardenable filler. The mixing device has inlet openings for the supply of the respective components over which the components are supplied to the mixing chamber. The components are stored in receiving containers such as cartridges or the like which are placed before them, whereby the mixing device is a part of a device for making available fillers.

Such devices for producing a ready-made filler have a seat for cartridges of the components in which the cartridges are placed. The component is pressed out of the cartridge by means of a punch with a stop surface.

Such a device for producing a ready-made filler for filling surfaces, which concerns for example vehicle bodies, is known from the DE 203 07 518 U1. The device has two store tanks placed on a base station, one of which is filled with a binder component, namely a filler component, and the other with a hardener component. Both components are supplied continuously to a mixing chamber by means of a metering device respectively over a feed channel, to a mixing chamber in which the components come into contact with each other.

With respect to the mixing device, it is disclosed in the DE 203 07 518 U1 that the mixing chamber is made of a hose section of a flexible hose on which press rollers are applied on the outside which compress the hose section and simultaneously drive it rotating around its longitudinal axis. The components are blend together by the friction which takes place and the adhesion of the components on the inner wall of the hose. After the material to be mixed has passed the hose section, it arrives to an outlet opening provided on the hose where it continuously comes out of the hose. The hose wall is made of an air-tight synthetic material so that the air surrounding the hose cannot arrive during the mixing process into the material to be mixed and cannot be included therein in form of pores or bubbles.

An adhesive pistol for applying in particular a two-component adhesive is known from EP 1 627 690 A, this pistol making possible in a simple manner a wide range of mixing ratios between a relatively viscous adhesive component and a relatively liquid adhesive component in an adhesive pistol. This adhesive pistol comprises a first cylindrical container which is provided with a first piston for pressing a relatively viscous adhesive component from a first cylindrical container, a second cylindrical container which is provided with a second piston for pressing a relatively liquid adhesive component from the second cylindrical container, a mixing unit into which the first cylindrical container and the second cylindrical container run and driving means for moving the first and the second piston, wherein the driving means are designed for a higher speed of the first piston than the speed of the second piston and wherein the first cylindrical container has a bigger inner diameter than the second cylindrical container.

EP 1 570 805 A discloses a device for producing a mixture made of several components, in particular for dental purposes. This device comprises at least two cartridges, whereby each cartridge contains a component of the mixture of several components and a piston which is conceived for pressing out the component from the cartridge and a driving device for the pistons in which the driving speed is adjustable, whereby the driving device has a step motor. For low number of revolutions per minute, the step motor should offer a higher moment of torsion compared with known direct current motors while it also makes available high numbers of revolutions per minutes, even if with a comparably low moment of torsion which is sufficient for a quick advance and return motion of the pistons.

U.S. Pat. No. 6,499,630 B discloses an arrangement for the proportional delivery of two or more free-flowing substances from two or more injection syringes, one of which at least is used also alone or in connection with other injection syringes, in particular for dental purposes. According to this arrangement, it is provided that the injection syringe bodies as well as the injection syringe pistons can be coupled with each other rigidly by removable coupling devices independently from the respective piston position in the forward direction. The coupling devices are configured in such a manner that the pistons and/or the injection syringe bodies can be connected in any relative position to each other in the advance direction. Moreover, this arrangement provides that the injection syringe bodies can be coupled only in one predetermined relative position to the piston rods of the pistons but in any relative position to each other.

The disadvantage of the known embodiments is that the containers for the components cannot be placed with a sufficient precision in the devices. Furthermore, there does exist the problem that air comes into the containers so that on the one hand the precision of the pressed out quantity is more difficult to calculate and air continues to be pressed out together with the component and arrives into the mixer so that the ready mass contains air inclusions which is not wished.

However, with respect to the mixing devices, it has been found in practice that the filler mixed with the device occasionally still has non-homogeneities. When the filler is being applied with a spatula on the surface of a vehicle body, the filler does not cure at the spots on which there is no hardener component. The elimination of such defects is connected with a relatively high expenditure since the filler has to be removed by grinding the body and then the filler has to be applied again on the body. If such defects remain unnoticed during the repair and the body is lacquered afterwards, it will even be necessary to lacquer again the spot. If the mixing devices is not used over a longer period, the filler may dry out in particular in the end area of the hose which results in the device being unusable. Moreover, the hose is subject to considerable wear since a considerable flexing work is taking place in the hose during the working of the device. Furthermore, the device is very complicated and requires much space because of the press cylinders or rollers.

A further disadvantage is to be seen in that the adding of the hardener component at least by means of a visual control is not possible so that it is not guaranteed that a continuous supply of the hardener component into the binder component takes place. Eventual mass fractions of the binder component which are not blended with the hardener component cannot be identified, whereby, due to the only simple supply of the hardener component over an inside situated supplying tube, it is not sure if air bubbles occur in the hardener component.

### SUMMARY OF THE INVENTION

Therefore, the object of the invention is to create a device for blending at least two components to a mixed substance which has a simple construction and for which it is secured that the containers of the components can be placed correctly. Furthermore, in a further auxiliary aspect, a homogeneous blending of a binder component with a hardener component should be guaranteed, whereby the mixed substance should cure reliably and completely in order to obtain a filler without inclusions of air. It is another object to carry out the removal of the components without inclusion of air into the system.

This object is met by a device as described above in connection with characterizing features also mentioned above.

It is advantageous that the container can be placed on the carrying element, this being defined by the arrangement element. Furthermore, due to the inclination, a complete emptying of the container is guaranteed. The inclination is preferably 5° or 10°.

Due to the providing of sealing elements on the carrying element as well as on or under the basic surface of the container, on the one hand a flowing out of component material is avoided. On the other end, a better protection against inclusion of air into the device and thus into the mixing device is achieved. The providing of projections, in particular in the area of admission openings, improves the snug fit of the openings to each other and reduces the risk of misoperation. If the picture of the carrying plate is also provided completely on the basic side of the component container, this improves the operability considerably. The stability of the container is simultaneously improved by the elements on the basic surface. For this reason, the lateral surface of the container can be connected with a Wymer seam which is material saving and is thus cheaper. If the basic surface is placed with respect to the lateral surface in such a manner that the elements are not projecting over the lateral surface, the risk of damaging of the container in case of improper treatment, in particular by a shock load, is improved in a simple manner. The providing of the inclination also on the sliding element causes a substantially complete emptying of the container and a securing that no air is accumulating under the sliding element so that it is then delivered through the opening.

A further teaching of the invention includes the technical teaching so that the mixer of the device has a hollow cylindrical stator part and a rotor part lodged rotatable concentrically about a longitudinal axis and the mixing chamber is configured in the art of an annular gap between the stator part and the rotor part, whereby several first mixing teeth moulded on the stator part extend radially inwards and several second mixing teeth moulded on the rotor part extend radially outwards into the mixing chamber in order to move the mixing teeth against one another by means of a rotational movement of the rotor part in the stator part and to create a blending of the two components, whereby the stator part has one, preferably two inlet openings connected with the mixing chamber for the hardener component and whereby the supply of the binder component and of the hardener component takes place by means of a control device to the mixing chamber so that a quantity of 0.1 gram to 0.5 gram, preferably 0.2 gram pasty or liquid hardener component is injected into the mixing chamber before the beginning of each mixing process before the admission of the binder component or before the beginning of the continuous mixing process with the rotational movement of the mixing teeth of the mixer running against one another, after which the admission of the binder component and the admission of the hardener component takes place.

This being, the invention starts from the idea that the mixer of the invention is configured as an unit of two components, namely the stator part and the rotor part. The binder component and the hardener component are brought into the mixing device by the respective inlet openings and arrive directly into the mixing chamber. Because of the rotational movement of the rotor part in the stator part at rest, the second mixing teeth rotate, whereas the first mixing teeth rest. Thus, a shearing or separation takes place in the mixed substance so that the hardener component is reliably blended with the binder component. The mixed substance comes out of the mixing chamber again over the delivery opening, whereby the delivery opening is placed distant from the inlet openings so that the mixed substance passes through the whole annular gap type mixing chamber. The flow movement of the mixed substance is produced by a pressure impact of the respective store tanks of the components so that the components are pressed into the mixing chamber by the respective inlet openings. The mixing ratio is defined on the base of the pressure or of the cross section of strem of the respective added components. The supply of the binder component and of the hardener component to the mixing chamber is carried out by means of a control device which has however another aim.

A quantity of 0.1 gram to 0.5 gram, preferably 0.2 gram pasty or liquid hardener component is injected into the mixing chamber before the beginning of each mixing process before the admission of the binder component or before the beginning of the continuous mixing process with the rotational movement of the mixing teeth of the mixer running against one another, after which the admission of the binder component and the admission of the hardener component takes place.

And this injection of a smallest quantity of hardener component is also released and supervised by the control device. Incorrect mixing results are avoided by the injecting of a smallest quantity of pasty or liquid hardener component before or at the beginning of each continuous mixing process into the mixing chamber of the device because without this preliminary injection, there are always incorrect mixing ratios. This comes from the fact that the mixing ratio is to 2% to 98% binder component and hardener component. The first quantity which is approximately 1 cm³ then contains either no hardener at all, or a so strongly reduced quantity of hardener that it can come partially to defective hardening processes. Thus, a usable hardening result is achieved by a benzoyl peroxide fraction (50% paste) between 0.8% to 5%. If this quantity fraction is not observed in overdosage and underdosage, there arise quality problems for the mixed substance. The underdosage does not lead to a sufficient end hardness. The overdosage leads to an undesired enrichment of the binder component (filler mass) with softener which is contained up to approximately 50% in the hardener paste. If these standard values are not observed for the hardening of the end product, it comes to erroneous end results for the lacquering work. For this reason, the solution according to the invention in claim 1 is particularly advantageous since usable hardening results are achieved.

This preliminary injection of a slight quantity of hardener component before the beginning of the proper supply of binder component and hardener component for the mixing process is not a preliminary supply in order to achieve a proportional delivery of the binder component and of the hardener component because the hardener component may not amount to more than 4% because otherwise non admissible reactions occur and among others a peroxide bleaching effect of the colour pigments contained in the hardener component.

An advantageous embodiment of this invention provides that the inlet openings directly run into the mixing chamber of the mixer, whereby the inlet opening for the supply of the hardener component does exist twice in order to create a redundant supply of the mixed substance with the hardener component. The requirement of a redundant supply of the hardener component is based on the ascertainment that non homogeneities in the mixed substance are normally caused by inclusions of air in the hardener component which cannot be surely avoided in practice even for a careful production of the hardener component. Since the hardener component has a percent of less than 5% and preferably of only approximately 2% of the whole volume of the material to be mixed, already the slightest inclusions of air in the hardener component result in that there are spots in the material to be mixed which do not contain any hardener component and thus do not cure. Since for the device according to the invention preferably two store tanks are provided for the hardener component and are connected with the mixing chamber by separate supplying channels, for the case that an air bubble would be once contained in one of the supplying channels normally some hardener component can still be supplied further to the mixing chamber by at least one other supplying channel. The risk that air bubbles would be simultaneously contained in all the supplying channels is very low and can be neglected. The device can be used in particular for the following binding agent systems listed below: polyester resins (unsaturated), styrene peroxide systems, epoxy resins (system with two components), polyurethane resin systems (system with two components), phenolic resin systems (system with two components), silicone systems (system with two components), acrylate systems (system with two components) or thiocoll systems (polydisulfide systems).

In order to be able to control the supply of the hardener component by means of a visual control, it is provided that at least the stator part is formed of a transparent material, whereby the transparent material is made from the group of the plastics comprising a polycarbonate (PC), a polymethylmetacrylate (PMMA) and/or a styrene-acrylnitrile (SAN). This being, it is furthermore advantageous to colour the hardener component. The supply of the hardener component is visible through the transparent stator part so that the operator can control the supply of the hardener component with his own eyes during the operation of the mixing device.

It is provided as a further advantageous embodiment of the invention that the first mixing teeth are placed on at least one first mixing teeth surface plane and the second mixing teeth on at least one second mixing teeth surface plane and that the mixing teeth surface planes are offset to each other axially in direction of the longitudinal axis in the art of storeys so that the second mixing teeth of the rotor part rotate radially in the respective intermediate spaces of the first mixing teeth of the stator part. Five mixing teeth surface planes can be provided on the whole by the first mixing teeth of the stator part so that the second mixing teeth of the rotor part are placed in the respective intermediate spaces on four mixing teeth surface planes on the whole. This being, the mixed substance goes from the inlet opening to the delivery opening the on the whole five mixing teeth surface planes of the first mixing teeth as well as the four mixing teeth surface planes of the second mixing teeth.

Advantageously, the mixing teeth have respectively front side faces which are turned respectively to each other in axial direction in order to position them against each other for an axially acting force between the stator part and the rotor part. Moreover, the front side surfaces are inclined with respect to a surface plane placed normally to the rotational axis under an angle α so that the front side surfaces slide off onto each other during the mixing procedure without material being removed from the mixing teeth and coming into the mixed substance. Thus, it is possible to keep the length of the rotor part short in direction of the rotational axis so that only a corresponding quantity of the mixed substance remains in the mixing chamber after having used the rotor part or the stator part. The device makes thus a slight consumption of the components possible. During the mixing procedure, the mixing teeth of the rotor part and the mixing teeth of the stator part are pushed against one another by the feed pressure of the components, whereby the front side faces which are oblique to each other slide onto one another without material being removed by abrasion and coming into the mixed substance. This being, the components of the mixed substance form between the front side faces sliding onto one another a thin film which acts as a sliding layer. The angle α under which the mixing teeth are inclined against one another with respect to the surface plane placed normally to the rotational axis can be at least 5°, eventually 10° and preferably at least 15°.

Another advantageous embodiment of the invention provides that the stator part comprises a supporting bearing surface on which the rotor part bears on the front side with mixing teeth moulded thereon and slides off in order to create an axial slide bearing arrangement. First the rotor part is inserted into the stator part by an open end side turned off the inlet openings until it abuts with the mixing teeth on the supporting bearing surface. Thus, an one-sided axial bearing of the rotor part in the stator part is possible. The geometry of the rotor part is adapted in such a way that the second mixing teeth of the rotor part are, when the mixing teeth abut on the front side on the supporting bearing surface, in the respective intermediate spaces of the first mixing teeth of the stator part. The axial bearing of the rotor part takes place in the joining direction of the rotor part into the stator part against the supporting bearing surface, whereby in case of an axial clearance in direction of the opening of the stator part there is the risk that the first and second mixing teeth come against each other. Because of the front side faces which are placed with an angle α, the rotor part is brought back against the supporting bearing surface in direction of the joining direction from which the rotor part is inserted into the stator part.

Advantageously, the rotor part has on the end side projections which penetrate into the inlet opening for feeding the binder component and rotate together with the rotation of the rotor part in order to reduce the thixotropy of the binder component already in the supplying channel of the inlet opening. When supplying the binder component into the mixing chamber, the thixotropy of the binder component is thus provisionally reversibly destroyed so that the hardener component is better distributed into the binder component, in particular if an air bubble would be once placed in one of the supplying channels for the hardener component and thus only a correspondingly reduced quantity of hardener component can be supplied to the mixing chamber.

For a polyester binder component, the difference between the hardener component and the binder component in the mixed substance must be clearly lower than 0.5 millimeter so that an uniform hardening of the mixed substance is obtained and that there does not remain any area in the mixed substance in which no hardening takes place. The projections are moulded on the rotor part in such a manner that they rotate at least partially inside the inlet opening for the binder component and that they bring kinetic energy into this.

Due to the bringing in-of kinetic energy, the flowability is reduced, in particular for low temperatures which can be clearly under 12° depending on the place of use so that the feed pressure foreseen for introducing the binder component is however sufficient for reducing the thixotropy. Due to the bringing in of kinetic energy, the thixotropy of the binder component can reversibly be reduced or even be completely eliminated.

A further embodiment of the invention provides that the rotor part has an end-sided open recess as a hollow cylinder into which a core with adapted geometry can be inserted by means of which the rotor part can be driven. The rotor part has a hollow space which is open on the one side. Due to the hollow cylinder type opening or recess, the core can be inserted in order to drive the rotor part with a rotational movement. This being, the core can be in connection for example with a motor to initiate the rotational movement into the rotor part. For the transmission of the torque, it is provided that the recess has snap-in ribs extending radially inwards from the body of the rotor part which snap-in into corresponding sparings in the core which are provided in the core. Preferably eight snap-in ribs can be provided, whereby another number of snap-in ribs is also sufficient or necessary. The transmission of the necessary driving torque to the rotor part can take place alternatively to the provided snap-in ribs with a polygon which can be configured for example as a hexagon socket screw.

Advantageously, the rotor part has sealing lips in order to seal the mixing chamber between the rotor part and the stator part and to prevent a discharge of the mixed substance. The sealing lips are provided as peripheral projections on the end side of the rotor part and are adjacent with a clearance dimension or a transition dimension to the inner wall of the stator part in order to create a sealing of the mixing chamber. This being, several sealing lips can be provided in order to improve the sealing effect. In the area of the mixing chamber, the rotor part has a first outer diameter which simultaneously forms the inner wall of the mixing chamber. A second diameter begins with the arrangement of the sealing lips, whereby it is bigger than the first diameter in the area of the mixing chamber. The delivery opening in the stator part is placed at the level of the mixing chamber so that the mixed substance can come out of the mixing chamber in the end area of the smaller first diameter. Only after the diameter widening, the sealing lips are placed so that a delivery of the mixed substance is reduced by the sealing lips on the enlarged diameter.

A further embodiment of the invention provides that the stator part has at least a plate-shaped moulding on the outer periphery, whereby at least one of the plate-shaped mouldings comprises a crescent-shaped snap-in contour into which at the start of the mixing device a pin element catches in order to secure the radial position of the delivery opening in the stator part. Preferably the delivery opening is situated in a vertical position directed to the bottom so that the operator can receive the ready-to-use mixed substance in a container. The pin element can be placed on a support or on a receiving device for the mixing device so that the mixing device which is made first of the rotor part joined in the stator part is pushed onto the core which is also placed on the receiving unit. Thus, the pin element secures the stator part against the torsion in order to guarantee that the delivery opening for the mixed substance remains in the position orientated vertically to the bottom.

The plate-shaped mouldings act as stabilizing collars which can simultaneously serve as handle for the operator to take the mixing device in order to avoid that the hands of the operator get dirty when changing the mixer. The crescent-shaped recess can alternatively be designed as a bore so that the pin extends into the bore. According to this embodiment, three plate-shaped mouldings are provided, whereby at least two of the three recesses verge into the delivery opening with the same uniform material and the crescent-shaped snap-in contour is provided on the third plate-shaped moulding placed at the end side. However, alternatively the crescent-shaped snap-in contour can also be provided in each of the plate-shaped arrangement.

A further embodiment of the invention provides that the rotor part has a cylindrical bearing section in order to create a slide bearing arrangement in the stator part for the radial bearing. The bearing section is provided as a cylindrical section on the outer side in the rotor part and can be used in the stator part in a cylindrical inner contour section and constitutes a slide bearing arrangement. Thus, the rotor is positioned axially ove the supporting bearing surface or the front side faces of the mixing teeth and radially by means of the bearing section.

Advantageously a hollow space is configured between the sealing lips in order to make possible to collect the mixed substance passing through the sealing lips. Moreover, the stator part has at least one outlet opening in the cylindrical section of the hollow space on the peripheral side in order to avoid the coming out of the mixed substance from the cylindrical bearing section. Because of the pressure of the mixed substance in the mixing chamber, it can happen that the mixed substance can despite of this come out through the sealing lips. A hollow space is provided to collect the mixed substance which comes out in order to avoid that the mixed substance comes out of the stator part or of the mixing device on the end side. Should the hollow space be filled with mixed substance, this can come out through the outlet openings in order to avoid definitively the coming out of the mixed substance from the area of the cylindrical bearing section. Preferably two outlet openings are placed, whereby a single outlet opening can also be provided preferably in the area of the delivery opening.

For supporting the mixing device on the apparatus for producing a ready-to-use filler for filling surfaces of, for example, vehicle bodies, the stator part of the mixing device carries at its end turned off the inlet openings an annular mounting which has fixing openings and which is removable in the art of a bayonet catch and which is connected rotatable with the stator part, whereby the rotatability is limited by means of stoppers in such a way that a fit of the inlet opening for the binder component A is achieved with the feeding of the binder component A and simultaneously a fit of both inlet openings for the hardener component B is achieved with the feedings of the hardener component B.

The annular mounting has two slit-shaped opposite openings arc-shaped parallel to the peripheral edge of the mounting, each opening having two guiding sections with different widths, the respectively wider guiding section being configured to insert a L-shaped guiding cam moulded on the lower peripheral edge of the stator part, whereby the width of the wider guiding section corresponds to the length of the free bent-off leg of the guiding cam and the respectively narrower guiding section of which has a width which corresponds to the thickness of the leg of the L-shaped guiding cam which is moulded on the lower peripheral edge of the stator part and parallel to the longitudinal direction of the mixing device.

The outer situated wall area of the narrower guiding section has a recess the depth of which corresponds approximately to the thickness of the bent-off leg of the L-shaped guiding cam.

Further measures which improve the invention are indicated in the subclaims or are represented in detail below together with the specification of a preferred embodiment of the invention with reference to the annexed drawings.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an apparatus for producing a ready-to-use filler for filling surfaces, for example, of vehicle bodies with a device for blending two components made of a stator part and a rotor part, wherein both parts have intermeshing mixing teeth;

FIGS. 1a-1d are perspective views of the device of FIG. 1;

FIG. 2 is a perspective view of a detail of the apparatus for producing a ready-to-use filler with inserted mixing device;

FIG. 3 is a perspective view of the mixing device consisting of the stator part and of the rotor part with controllable feedings for a binder component and two hardener components from store tanks connected with the mixing chamber, wherein the stator part has at its end turned off the feedings for the components an annular mounting removably connected with the stator part and fixedly connected with the apparatus;

FIG. 4 is an enlarged top view of the annular mounting;

FIG. 5 is an enlarged view from below of the annular mounting;

FIG. 6 is a vertical sectional view according to line V-V of FIG. 4;

FIG. 7 is a view from below of the stator part of the mixing device with the guiding cams catching into the mounting;

FIG. 8 is a lateral view of a part of the stator part with the molded guiding cams;

FIG. 9 is a graphical exploded view of the mixing device with the stator part and the rotor part;

FIG. 9A is a graphical view of the stator of the mixing devices with the feedings for the binder component and for the hardener component;

FIG. 10 is a view of the mixing device in which the rotor part is placed in the stator part and the stator part is represented cut;

FIG. 11 is a cross sectional view through the mixing device with a cut stator part as well as a cut rotor part;

FIG. 12 is a longitudinal sectional view through the stator part;

FIG. 13 is a top view of the stator part, wherein the top view is made at the one end from the direction of the inlet openings;

FIG. 14 is a lateral view of the rotor part of the mixing device;

FIG. 15 is a partial cross sectional view through the rotor part as well as the stator part along an annular peripheral mixing area inside the mixing chamber, wherein the teeth of the stator part are represented hatched and the teeth of the rotor part are represented non hatched;

FIG. 16 is a partial view of a first embodiment of a container according to the invention in connection with a corresponding carrying plate;

FIGS. 17a-b are further lateral views of a first embodiment of a container according to the invention in connection with a corresponding carrying plate;

FIGS. 18a-b are views of a second embodiment of a container according to the invention in connection with a corresponding carrying plate; and

FIG. 19a-b are a top view and a sectional view of a pressure plate according to the invention.

### DESCRIPTION OF THE PREFERRED EMBODIMENTS

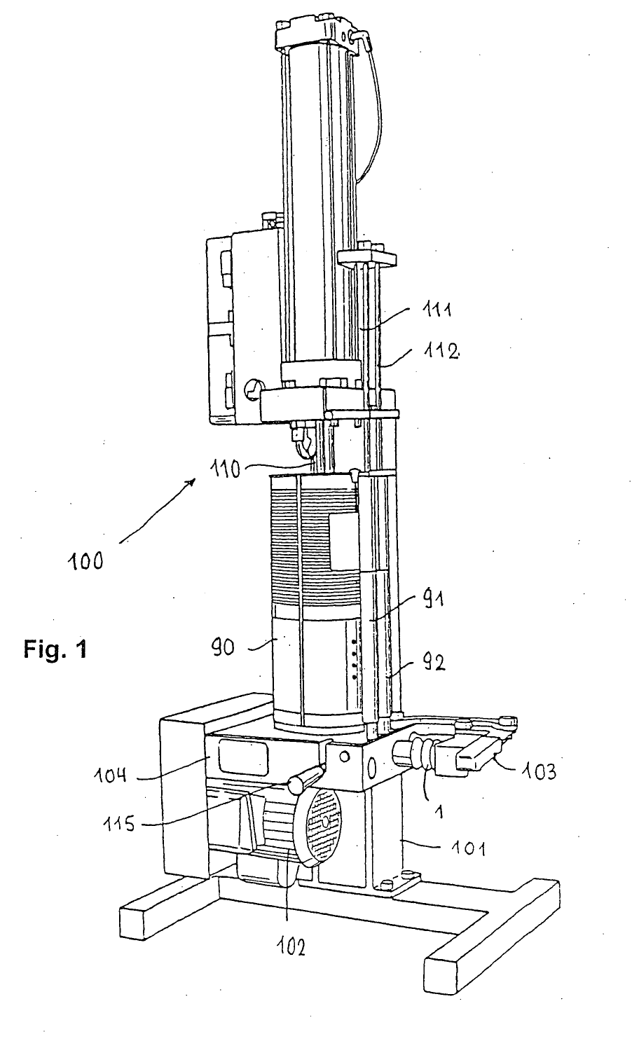

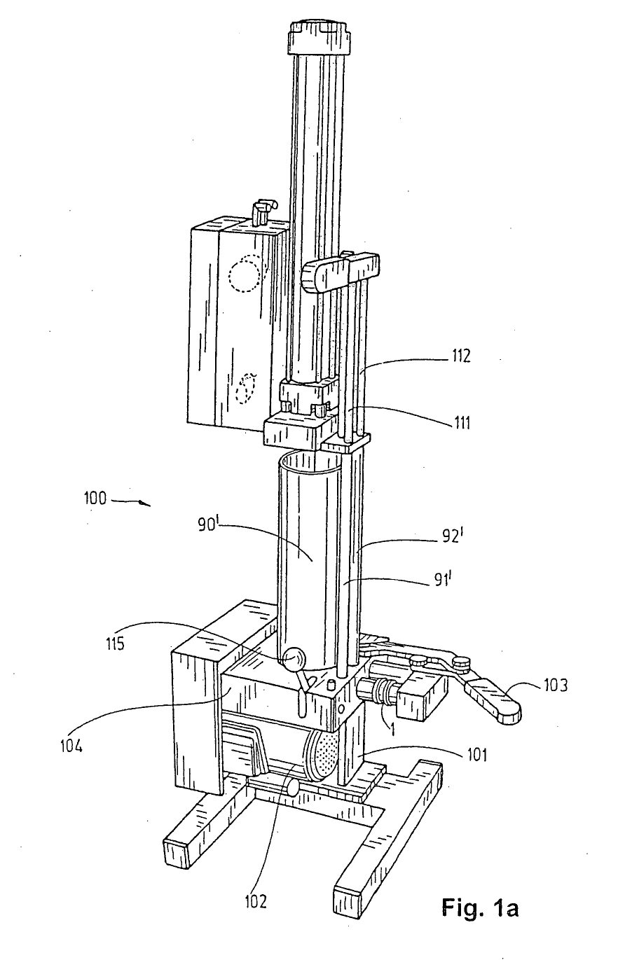

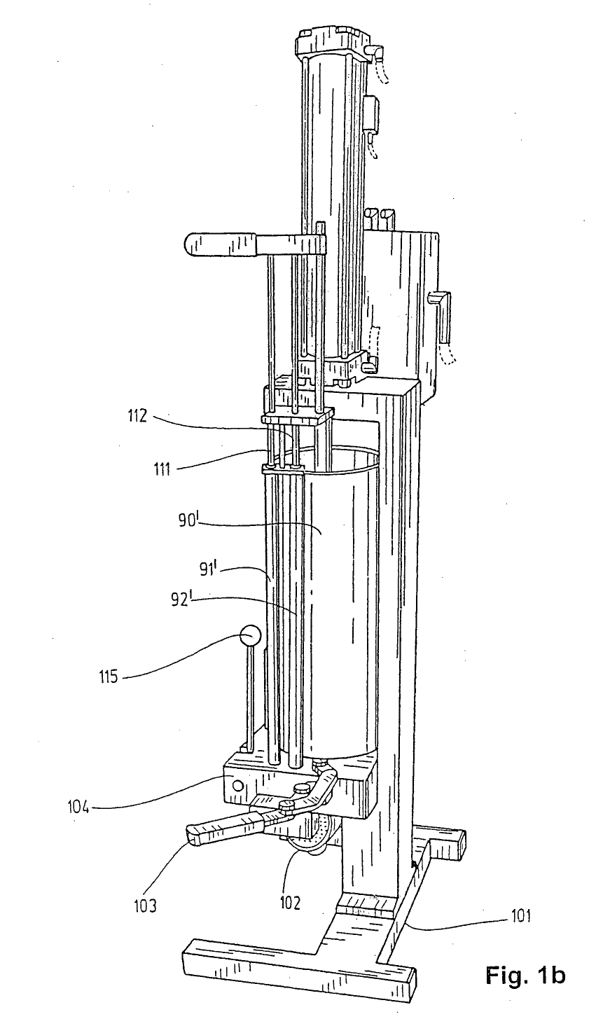

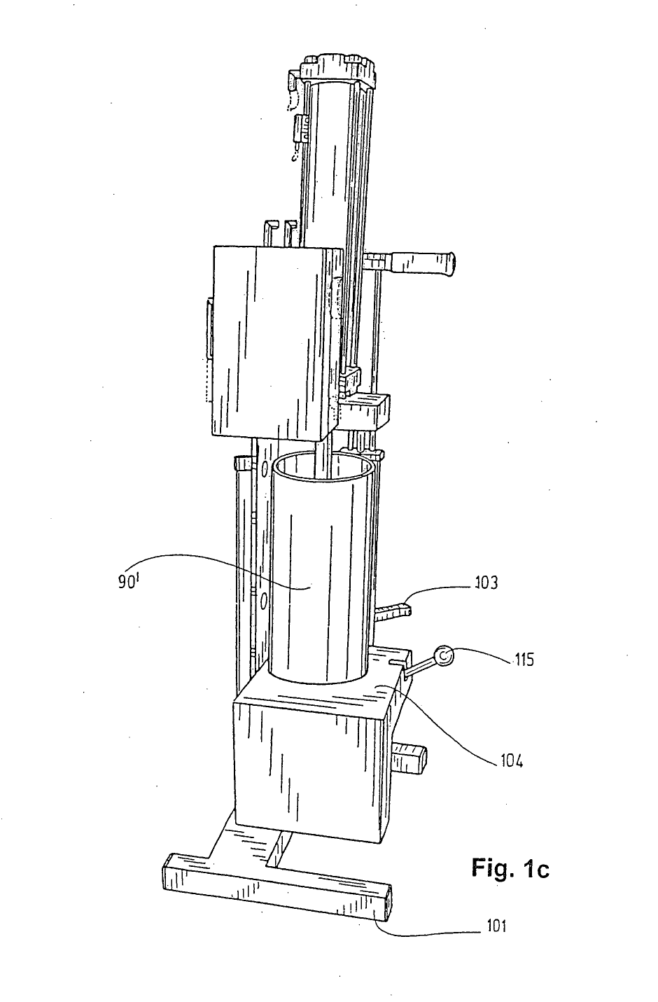

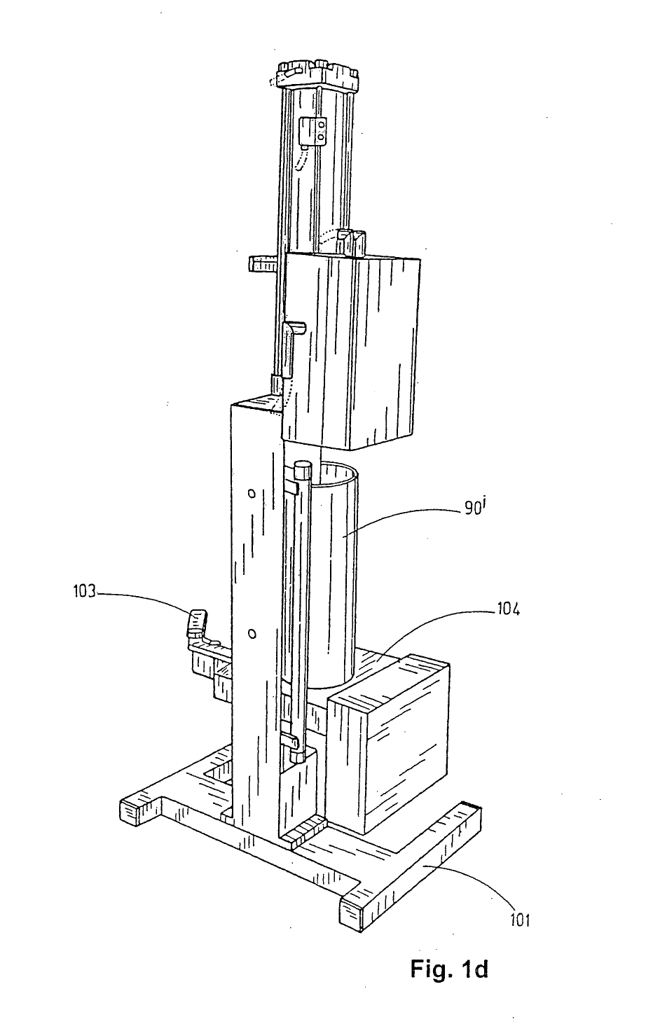

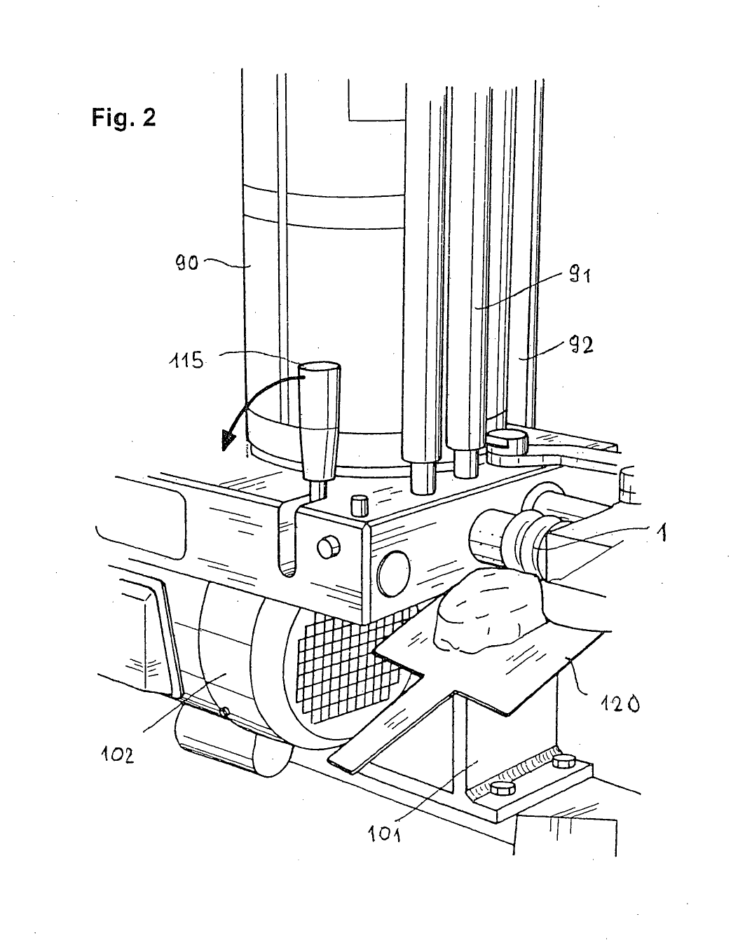

The apparatus 100 represented in FIG. 1 for producing a ready-to-use filler for filling surfaces which concern for example vehicle bodies from a binder component A and at least one hardener component B comprises a stand footing 101 with a driving motor 102 and a mounting 103 for a mixing device 1 which consists of a stator part 16 and a rotor part 19, whereby an annular gap is configured between the two cylindrical parts 16 and 19 which forms the proper mixing chamber 14. The stand footing 101 has a carrying plate 104 for receiving a store tank 90 for the binder component A and for the embodiment shown in FIGS. 1, 2, 10 and 12 two store tanks 91, 92 for a hardener component B, B1. More than two store tanks can be provided for the hardener component B. The store tanks 90, 91, 92 are positioned nonskid and stationary on the carrying plate 104. The outlet openings of the store tanks 90, 91, 92 correspond with supplying channels in the carrying plate, whereby these supplying channels are then connected with the leading-in openings 17a, 17b, 17′b of the mixing device 1 when the apparatus is set into operation. Piston rods are actuated by means of motor drivable hydraulic cylinders 110, 111, 112, piston rods the free ends of which carry plate-shaped pistons so that, with the operation of the hydraulic cylinders 110, 111, 112 the piston rods are moved with the pistons situated in the inside spaces of the store tanks 90, 91, 92 in piston rod longitudinal direction in order to press the contents of the store tanks 90, 91, 92 into the mixing device 1. The actuation of the motor 102, i.e. the switching on and off, is controlled by the actuation lever 115 so that the filler produced can be taken out in the quantity respectively designed onto a spattle 120 (FIGS. 1 and 2).

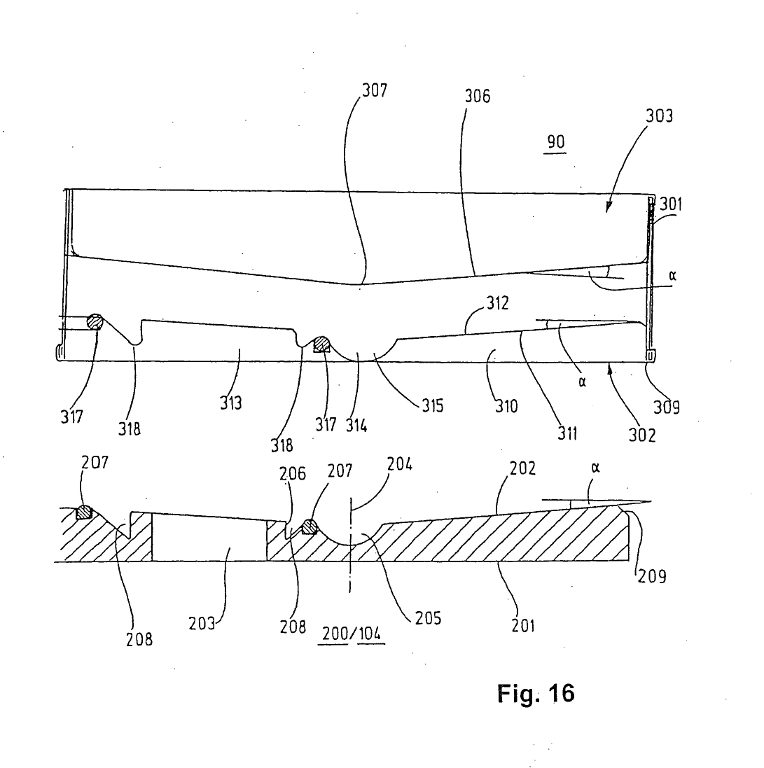

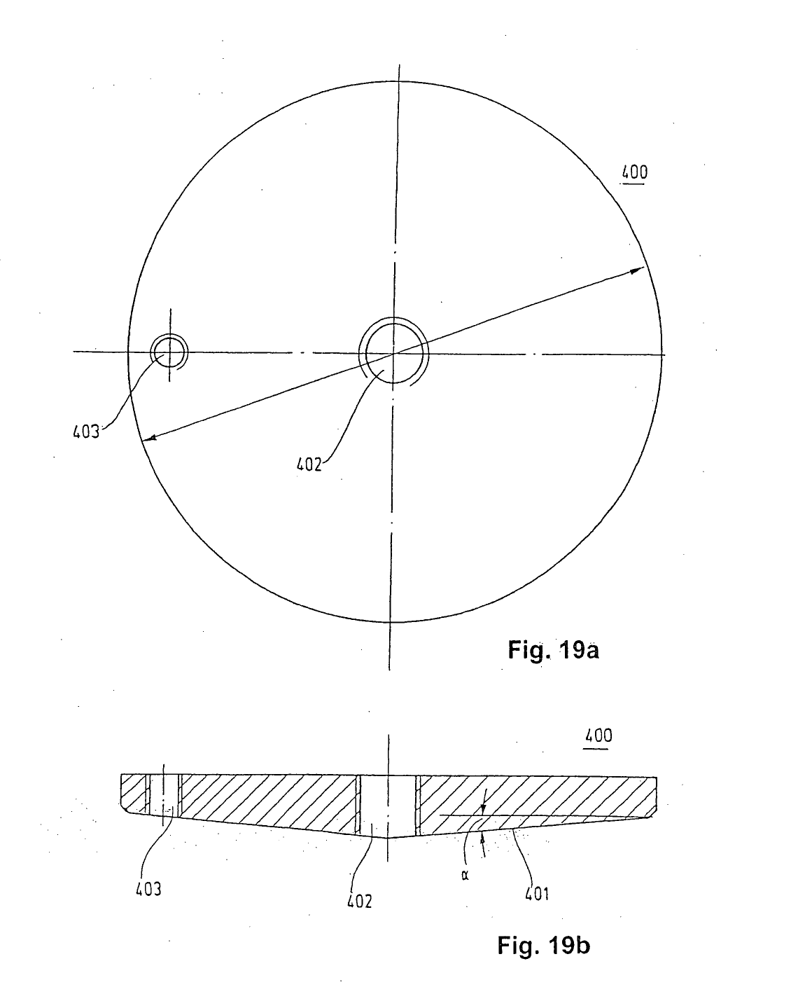

FIGS. 1a to 1d show further spatial representations to FIG. 1. Container seats 90′, 91′, 92′ for the components A and B or B1 and B2 are provided on the carrying plate 104. A profiled section is provided inside the container seat 90′ as represented in FIG. 16 to FIG. 19.

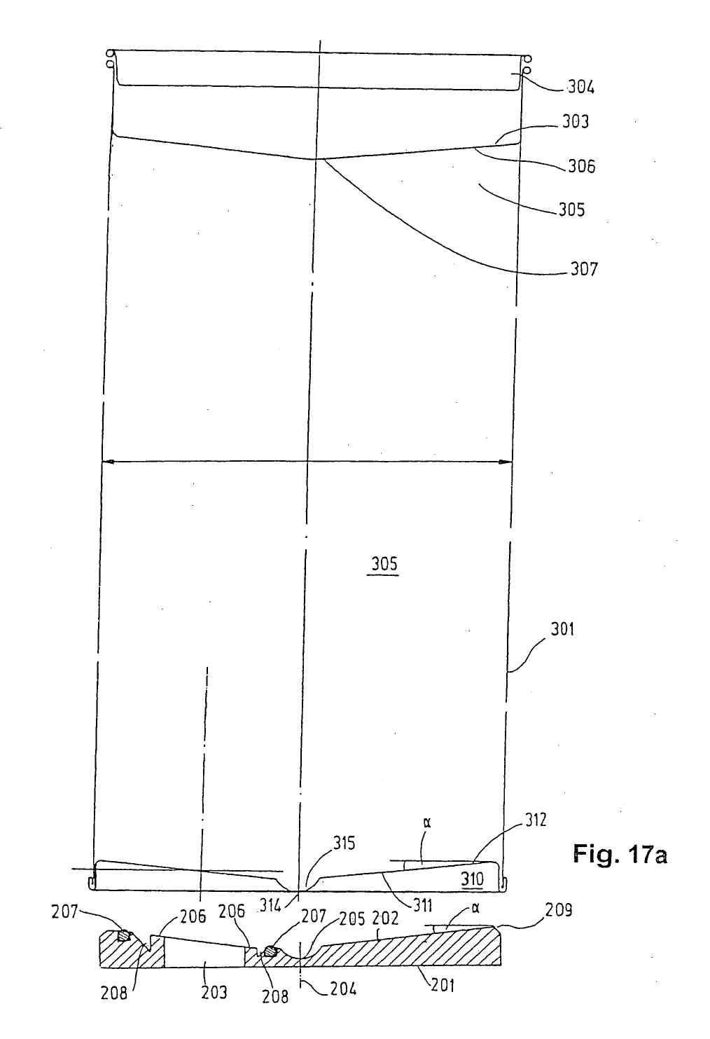

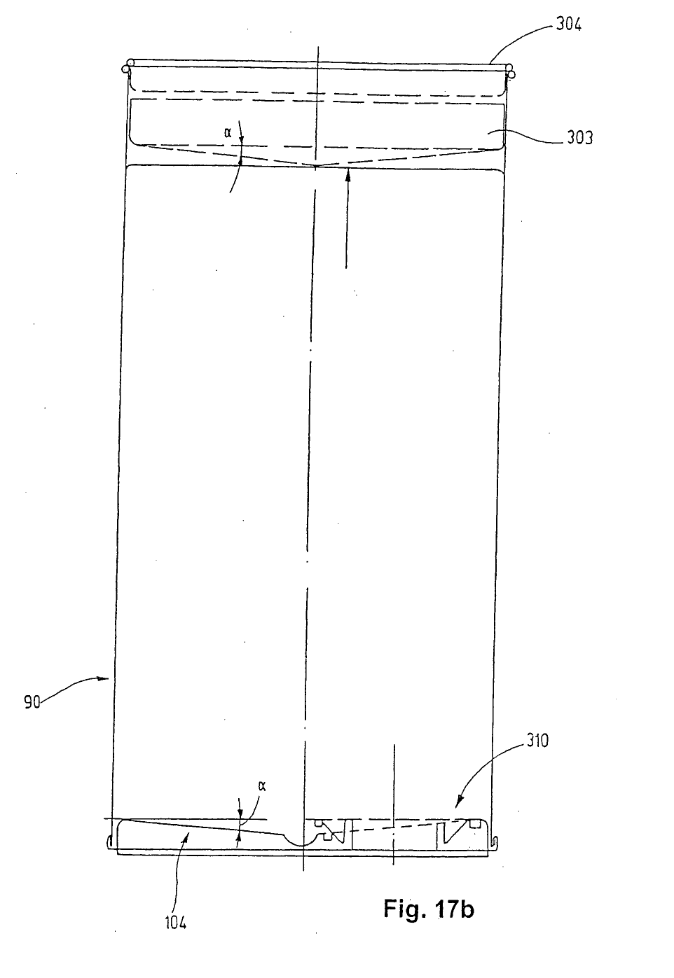

FIG. 16, FIG. 17a and FIG. 17b show a first embodiment of the carrying plate 104 according to the invention or a correspondingly profiled section 200 of the carrying plate 104 for receiving a container 90. A lower side 201 is placed on the carrying plate 104. The upper side 202 in inclined with respect to the horizontal line about the angle α to the center 204. In FIG. 16 and FIG. 17a, b is a 5°. A deepening 205 is placed in the center 204. A opening 203 through which the component mass can pass is provided eccentrically with respect to the center 204. The opening 203 is extended to the upper side 203 by channel walls 206. The channel wall ends are situated in the inclination of the upper side 202. Deepenings 208 are provided on the side of the channel 206 which is opposite the opening 203. Sealing elements 207 are provided annexed to the deepening 208 here as an annular sealing. A mounting aid which causes a simpler and more precise setting of the container 90 on the carrying plate 104 is provided as a chamfer on the outer side.

The container 90 is represented in FIG. 17a corresponding above the carrying plate 104. This container is made of a lateral envelope surface 301, a base surface 302 and a cover 304 under which a sliding bottom 303 is situated by which the component 304 is pressed out of the container 90. The lateral surface is assembled with a Wymer seam.

The base surface 302 is made of a moulded part 310, the upper side 312 of which is inclined to the center 314 like the upper side 202 about the angle α. This being, α is identical. A deepening 31 is provided in the center 314. An opening 313 through which the component mass can pass is provided eccentrically to the center 314. The diameter of the opening 313 is the sum of the diameter of the opening 203 and of the outer side of the channel wall 206. The moulded part 310 has a deepening 318 which can catch into the deepening 208. Moreover, a sealing 317 which acts together with the sealing 207 is also provided.

A sliding bottom 303 is represented in FIGS. 16 and 17a, the lower side of which is also inclined about the angle α to a center 307. The inclination causes a better air displacement and acts against a discharge of air into the mixing device 1.

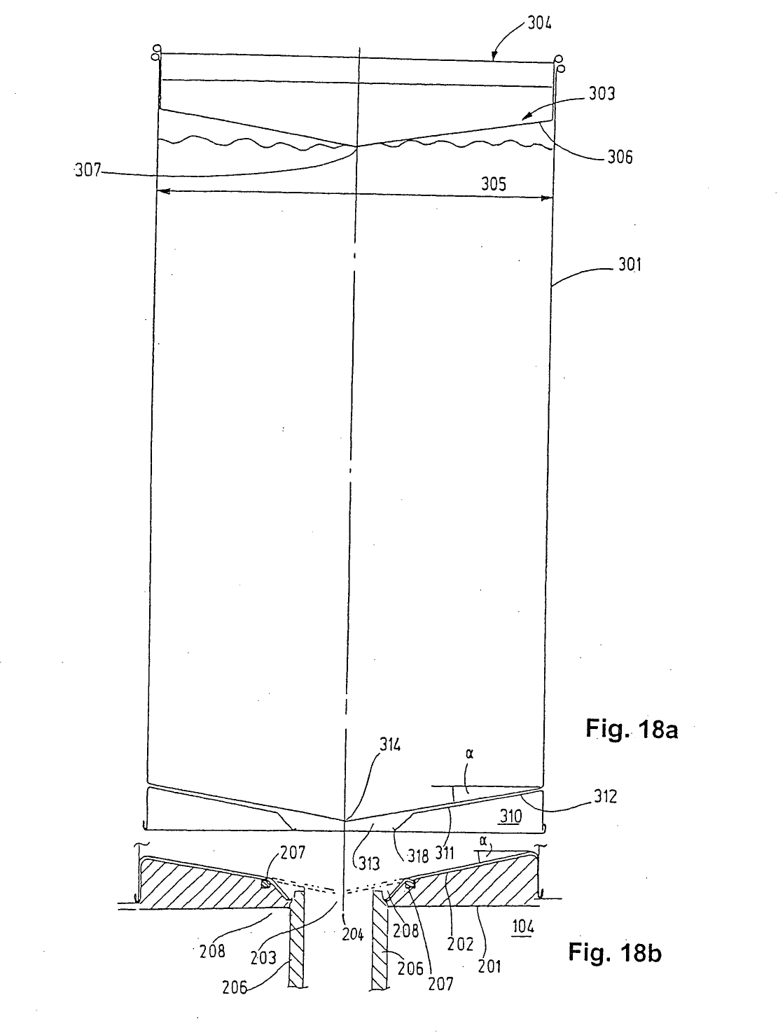

FIG. 18a and FIG. 18b show a further embodiment of the carrying plate according to the invention and of the container 90. This being, the opening 203, 313 is placed centered. The upper side 202, 312 is inclined to the center 204, 314. In this embodiment A is 10°. The opening 203 is surrounded by a channel which penetrates into the opening 203. There is again a deepening 208, 318 on the outer side and annexed to it a sealing 207 is provided which is provided in this embodiment only on the carrying plate 104 but hot on the base plate 310. Furthermore, FIG. 18a shows how the base plate 310 is placed on the carrying plate 104.

The placing of the container 90 on the carrying plate 104 is carried out in such a manner that the outer edge 309 is placed in the area of the base plate 302 onto the chamfers 209. The deepenings 205, 315 are placed over each other and mesh. If the openings 203, 313 are now over each other, the deepenings 318 can slide into the deepenings 208 and the lower side 311 of the base surface 302 comes to rest on the upper side 202 of the carrying plate 104.

The apparatus 100 shown in FIG. 1 comprises a device 1 for mixing two components, the binder component A being supplied by the store tank 90 and the hardener component B, B1 by two store tanks 91, 92.

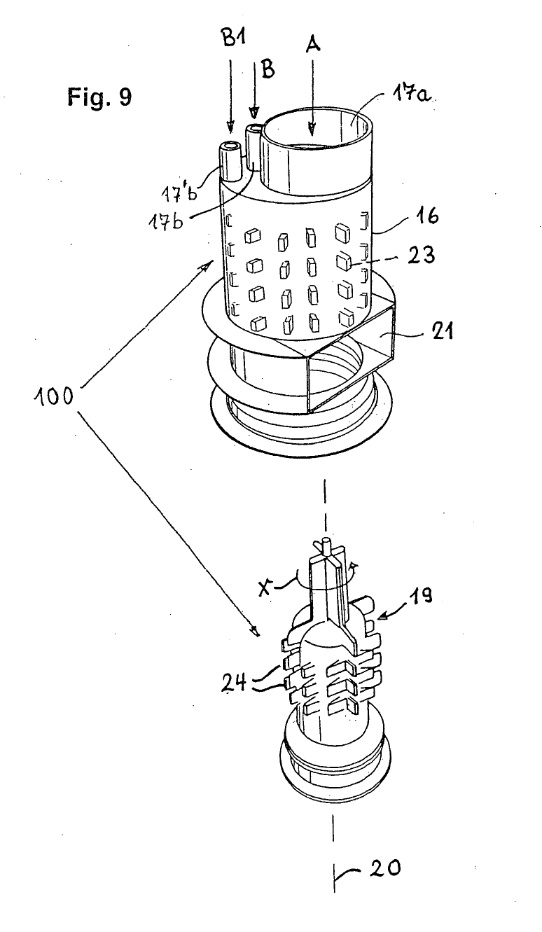

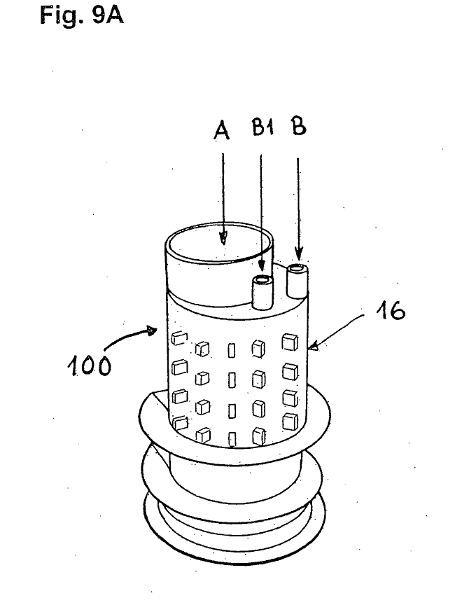

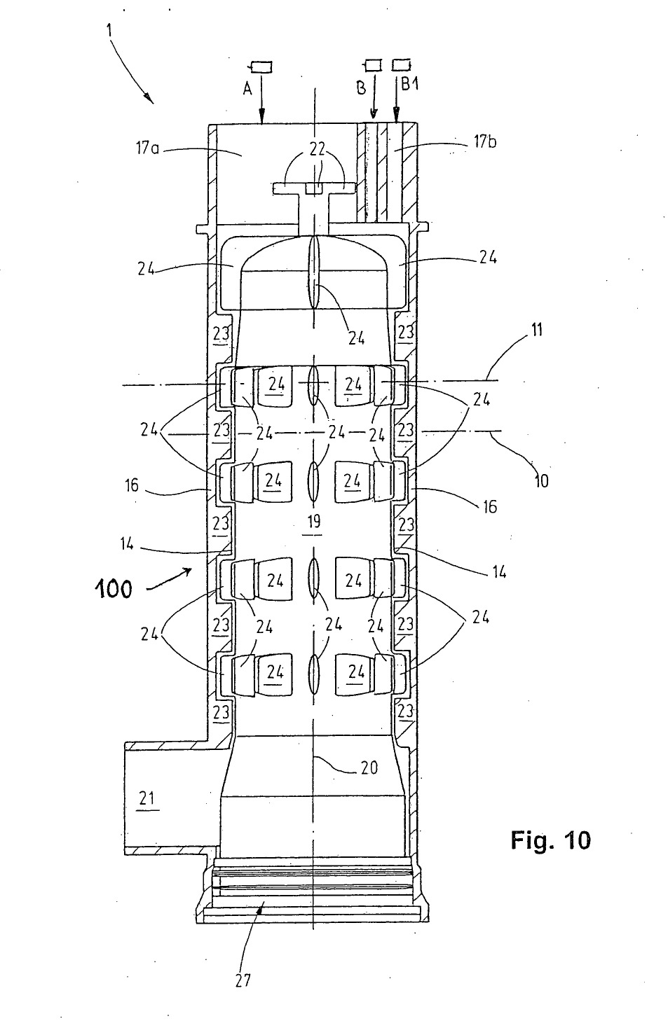

The mixing device 1 represented in FIGS. 9, 9A and 10 comprises a stator part 16 and a rotor part 19. The rotor part 19 is placed in the stator part 16 and is positioned rotatable therein. In C the driver for the rotor part 19 attacks (FIG. 9). For the supply of the mixed substance, the stator part 16 has inlet openings 17a, 17b and 17′b, whereby the binder component A is supplied through the inlet opening 17a and the hardener component B, B1 through the two inlet openings 17b and 17′b. For illustrating the supply of the three components, respective arrows are characterized with A, B and B′. The rotor part 19 is positioned rotatable about a longitudinal axis 20, whereby projections are provided at the end side on the rotor part 19, projections which rotate with the rotor part 19 and which extend into the inlet opening 17a. An increase of the flowability of the thixotrope binder component A is caused herewith, whereby the projections 22 are placed several times at the end side on the rotor part 19.

The fixing and holding of the mixing device 1 on the mounting 103 of the stand footing 101 of the device 100 takes place by means of an annular mounting 120. The stator part 16 carries at its end 16a turned off the inlet openings 17a, 17b, 17′b the annular mounting 120 which has fixing openings 121 and which is removable as a bayonet catch and which is connected rotatable with the stator part 16, whereby the rotatability of the mixing device is limited by means of stoppers 122, 123, 122a, 123a in such a manner that a fit of the inlet opening 17a for the binder component A is achieved with the feeding of the binder component A and simultaneously a fit of the two inlet openings 17b, 17′b for the hardener component B with the feedings for the hardener component B.

This annular mounting 120 has two opposed arc-shaped slit-shaped openings 125, 135, each opening 125, 135 having two guiding sections 125a, 125b, 135a, 135b with different widths, the respectively wider guiding section 125a, 135a being configured for introducing one of two L-shaped guiding cams 140, 140′ moulded on the lower peripheral edge 16a of the stator part 16, whereby the width of the wider guiding section 125a, 135a corresponds to the length of the free bent-off leg 140a, 140′a of the guiding cam 125, 135 and the respectively narrower guiding section 125b, 135b has a width which corresponds to the thickness of the leg 140b, 140′b of the L-shaped guiding cam 140, 140′, leg which is moulded on the lower peripheral edge 16a of the stator part 16 and running parallel to the longitudinal direction of the mixing device 1.

The wall area 125c, 135c which is situated respectively on the outside of the narrower guiding section 125b, 135b has web-type wall sections 125d, 135d by configuring tongue-type edge areas 127, 137 so that groove-type recesses are formed, the depth of which corresponds approximately to the thickness of the bent-off leg 140a, 140′a of the L-shaped guiding cam 140, 140′.

The annular mounting 120 is made of a synthetic material or of metal.

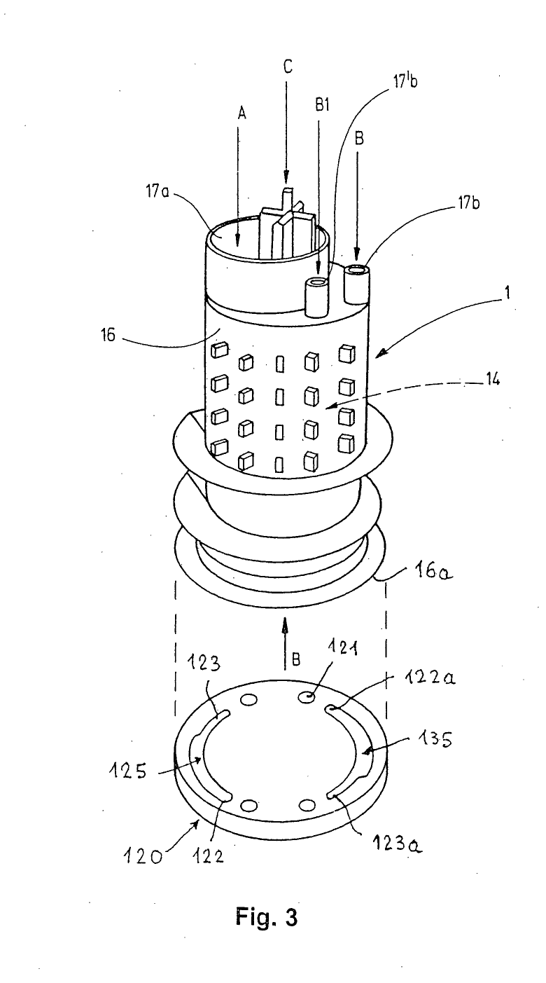

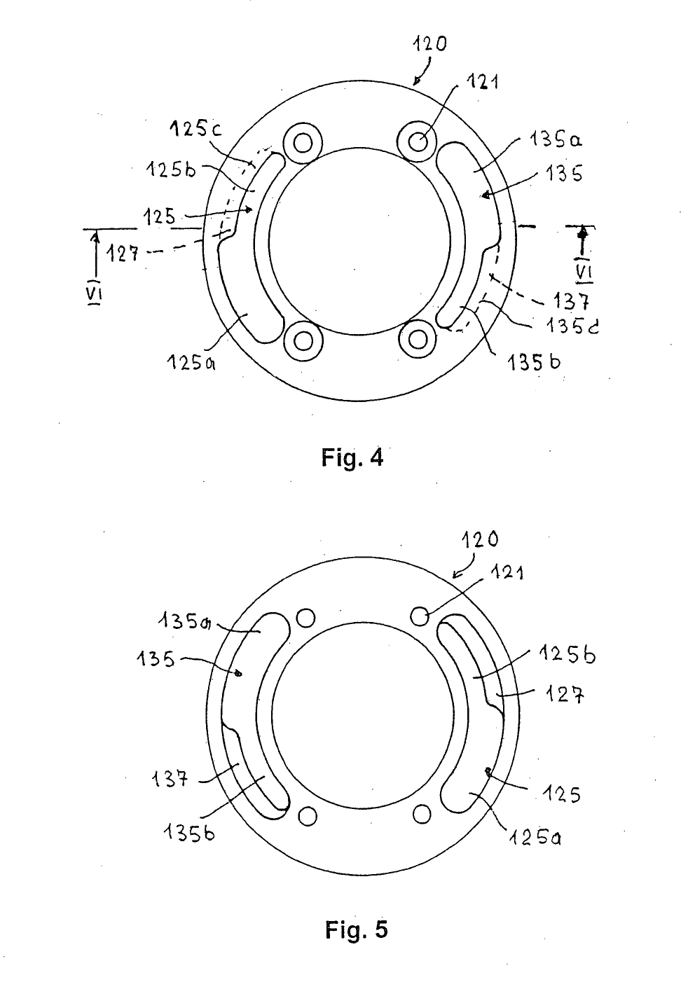

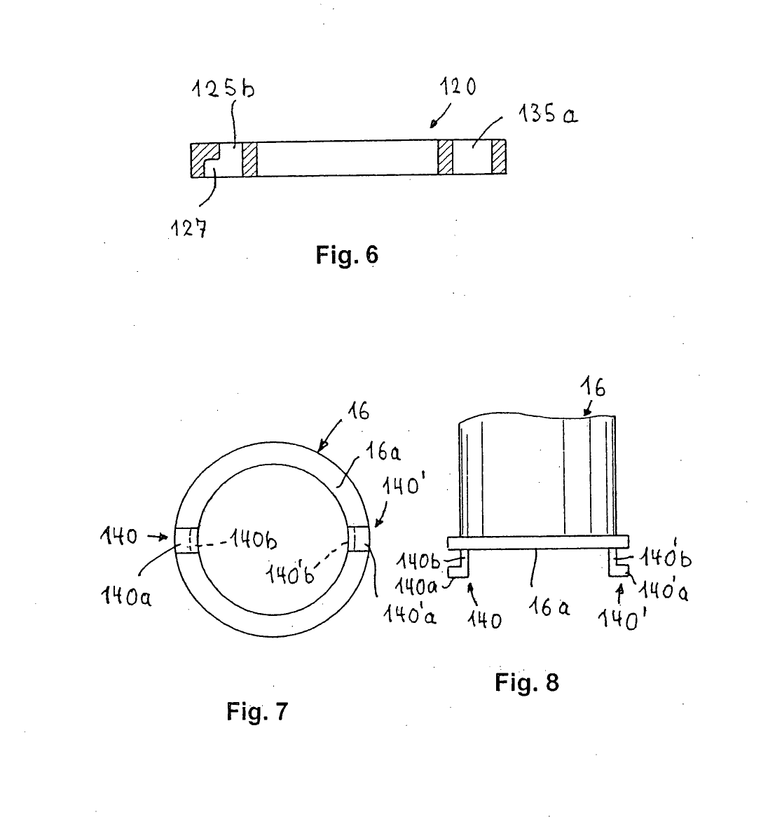

The annular mounting 120 is inserted as follows. The annular mounting 120 is fixed on the mounting 103 of the stand footing 101 of the apparatus 100 in such a manner that the slit-shaped openings 125, 135 are turned with their wider guiding sections 125a, 135 and with their narrower guiding sections 125b, 135b to the mixing device 1 (FIG. 4). After fixing the annular mounting 120, the mixing device 1 is set onto the mounting 120 in such a manner that the L-shaped guiding cams 140, 140′ of the mixing device 1 are passed through the wider guiding sections 125a, 135a of the slit-shaped openings 125, 135. Thereafter the mixing device 1 is twisted about its longitudinal axis until the free legs 140a, 140′ of the L-shaped guiding cams 140, 140′ hit at the ends of the narrower guiding sections 125b, 135b of the slit-shaped openings 125, 135. This being the free legs 140a, 140′a of the L-shaped guiding cam 140, 140′ grip under the tongue like edge areas 127, 137 of the narrower guiding sections 125b, 135b which are adjacent to the peripheral edge of the annular mounting 120 (FIG. 6). Thus, the mixing device 1 is held bayonet catch like on the annular mounting 120 and thus on the mounting 103 of the stand footing 101 of the device 1. When the mixing device 1 is twisted in the reverse direction, the bayonet catch is unlocked and the mixing device 1 can be removed from the apparatus 100 in order to be able to replace a used mixing device 1 with a new mixing device. Due to this type of the mounting of the mixing device 1 on the apparatus 100, it is achieved that, after having inserted the mixing device 1 into the annular mounting 120, the rotatability of the mixing device 1 is limited by the stops 122, 123, 122a, 123a at the ends of the slit-type openings 125, 135 of the annular mounting in such a way that a fit of the inlet opening 17a for the binder component A with the feeding for the binder component A is achieved and simultaneously a fit of the two inlet openings 17b, 17′b for the hardener component B with the feedings for the hardener component B, B1 is achieved (FIG. 3).:

Due to the projections 22 at the end of the rotor part 19, kinetic energy is brought into the binder component A in order to destroy their thixotropy reversibly. Thus, the binder component A can be blended more uniformly with the two hardener components B and B1. The mixing chamber 14 is configured as an annular gap between the rotor part 19 as well as the stator part 16. The components to be mixed A, B and B1 are fed into the mixing device 1 in such a manner that they blend with each other only in the inside of the mixing chamber 14. Thus, after termination of the mixing operation and the separation of the mixing device 1, al the mixed substance rests from a corresponding base station remain in the mixing device 1. This device is configured as a one-way part which is thrown away after having been used and which is replaced by a corresponding new part. The hardener component B and B1 is fed by the two inlet openings 17b and 17′b to the mixing chamber 14 in which the hardener components are blended with the binder component A. This being, the feeding of the components A, B and B1 takes place in the following order.

First a slight quantity of hardener component B is fed to the mixing chamber. Then the binder component A and the hardener component B1 are simultaneously fed so that the binder component A which comes into the mixing chamber joins with the hardener component B which is already in the mixing chamber and is already blended with it. This mode of operation results in that the binder component A wich flows into the mixing chamber joints with the already existing hardener component B and is blended with it so that no binder component fraction which has no hardener component can come out. Thus, there always comes out of the mixing chamber binder component mixed with the hardener component so that the mixture which first comes out does contain hardener component and can thus immediately be processed further. The hardener component is then fed to the mixing chamber 14 before the binder component flows into the mixing chamber. This preliminary feeding of hardener component is achieved by being controlled in such a way that a corresponding control of the metering devices 90, 91 and 92 takes place for both hardener components and for the binder component (FIG. 10). Moreover, the stator of the mixing devices can also have only one feeding for the hardener component. In this case, first a supply of a slight component of hardener component into the mixing chamber 14 takes place by the control of the metering device and then the feeding of the binder component takes place together with the feeding of further hardener components.

The components to be mixed are continuously fed through the mixing chamber 14 by means of preceding metering devices 90, 91, 92 to a delivery opening 21 placed on the stator part 16 which is placed in flow direction behind the inlet openings 17a, 17b and 17′b and after the mixing chamber 14. Several first mixing teeth 23 which extend radially inwards into the mixing chamber 14 are placed on the stator part 16, whereas second mixing teeth 24 which extend radially outwards into the mixing chamber 14 are placed on the rotor part.

The mixing teeth 23, 24 are moved against each other by means of a rotational movement of the rotor part 19 in the stator part 16 so that a blending of both components A, B and B1 is caused. When the preliminary admission of the hardener component B has taken place and a part of the following binder component A has blended with the hardener component B and the two other components A and B1 are pressed into the mixing chamber, the further admission of the hardener component B can be stopped. Binder component A and hardener component B1 which have been supplied to the mixing chamber are then blended together. These two components A and B1 are fed in a predetermined ratio to the mixing chamber until the respectively desired quantity of mixed substance is obtained. The first mixing teeth 23 are placed on a first mixing teeth level 10 and the second mixing teeth 24 on a second mixing teeth level 11. On the whole five first mixing teeth surface planes 10 and four second mixing teeth surface planes 11 are provided which are placed interleaved with each other alternatively in axial direction along the longitudinal axis 20. Due to the rotational movement of the rotor part 19, the second mixing teeth 24 rotate radially in the intermediate spaces of the first mixing teeth 23 which are moulded stationary on the stator part 16. There thus results a shearing or division movement between the mixing teeth 23 and 24 so that the mixed substance is optimally thoroughfully mixed.

A preliminary mixing of both components A, B and/or B1 takes place by the bigger second mixing teeth 24 which are placed at the front end of the rotor part 19 so that these components are preliminarily mixed by this mixing teeth surface plane. The bigger configured second teeth 24 placed at the end are placed four times on the periphery of the rotor part 19 and change respectively into the projections 22 which also exist four times. At the open end, the stator part 16 has a reception opening in which a cylindrical bearing section 27 which is moulded on the rotor part 19 causes a bearing of the rotor part 19 in the stator part 16. Thus, a radial positioning of the rotor part 19 is created in the stator part 16. The diameter fit of the cylindrical bearing sections 27 on the rotor part 19 is dimensioned in the diameter so that a corresponding slide bearing arrangement is created.

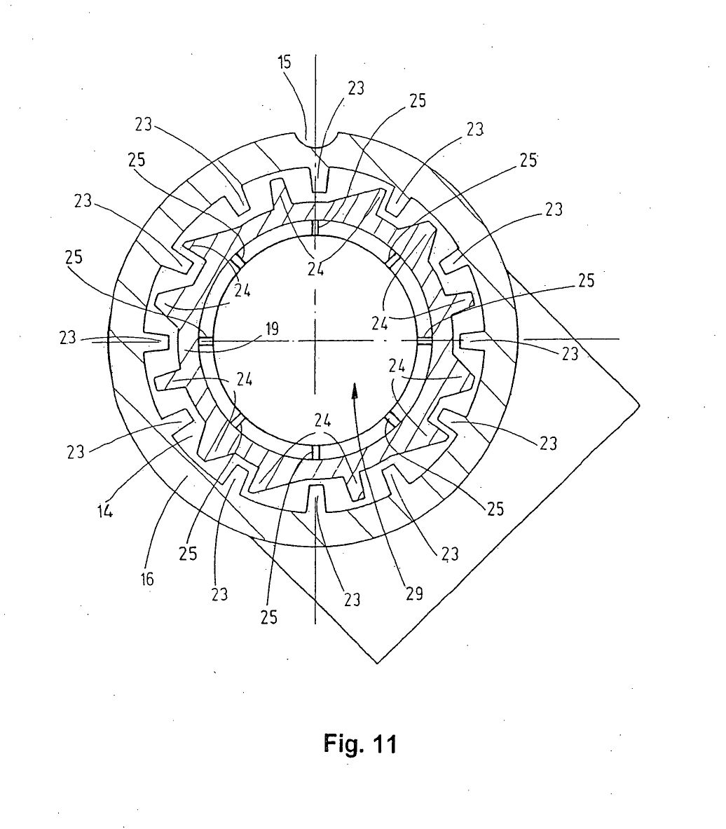

FIG. 11 shows a cross section of the mixing device 1, whereby the stator part 16 as well as the rotor part 19 are represented in cross section. In particular the arrangement of the mixing teeth 23 and 24 is illustrated therein, whereby the second mixing teeth 24 are moulded on the rotor part 19 in such a manner that for a production of the rotor part 19 by injection moulding only a single division plane is sufficient for using a one stroke injection moulding tool. Furthermore, it can be recognized that the mixing teeth 23, 24 are moulded respectively in the same material on the stator part 16 as well as on the rotor part 19 so that the mixing device 1 is made only from these two components. The rotor part 19 has an inner area which is configured hollow as a recess 29. Snap-in ribs 15 run radially inwards into the recess 29, whereby eight snap-in ribs 25 on the whole are placed on the periphery. The stator part 16 comprises a crescent-shaped snap-in contour 15 which is provided on the outer periphery.

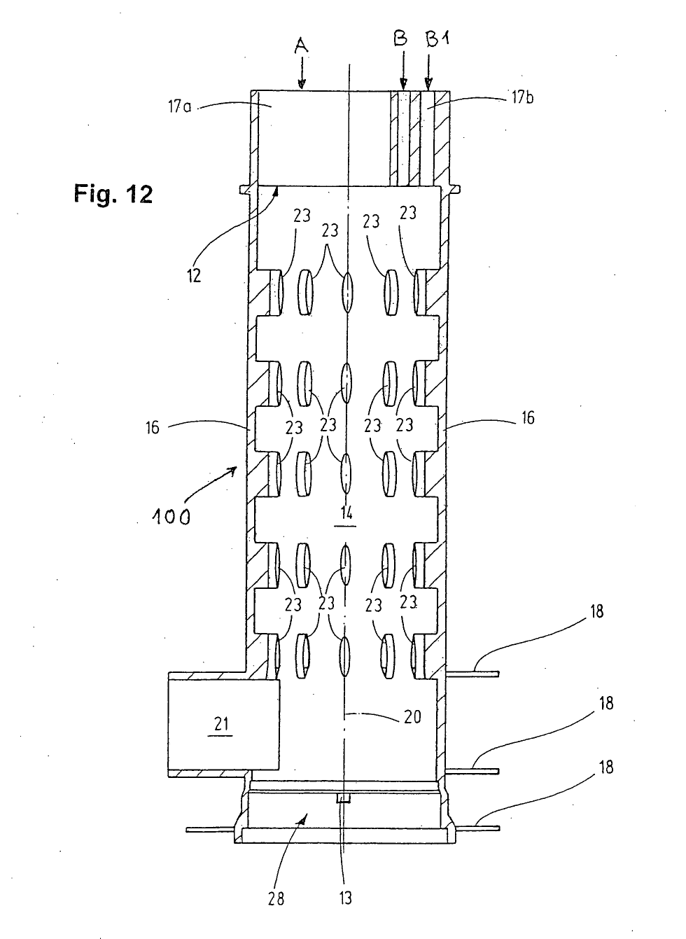

FIG. 12 illustrates a cross-section of the stator part 16 which is represented cut along the longitudinal axis 20. The arrangements of the inlet openings 17a, 17b, 17′b which run directly into the mixing chamber 14 are represented in section. The first mixing teeth 23 are placed in the wall of the stator part 16 on the five surface planes on the whole, whereby twelve first mixing teeth 23 on the whole are provided distributed over the periphery on respectively one mixing teeth surface plane. At the end of the mixing chamber 14 which is situated opposite to the inlet openings 17a, 17b and 17′b, a delivery opening 21 is provided which brings the mixed substance radially outwards out of the mixing chamber 14 (FIG. 9). Plate-shaped mouldings 18 are configured on the outer periphery of the stator part 16, whereby on the whole three plate-shaped mouldings 18 are provided at the level of the delivery opening 21 as well as on the end side on the stator part 16. The inlet opening 17a or 17b changes a the level of a supporting bearing surface 12 into the mixing chamber 14, whereby the supporting bearing surface 12 forms an axial bearing of the rotor part 19 which is not represented here. The stator part 16 is placed at the end site on the rear end which is situated opposite the inlet openings 17a, 17b, 17′b so that the rotor part 19 can be joined into the stator part 16 through this opening. The stator part 16 has a hollow space 28 configured as a section in the area of the opening in order to receive the mixed substance which is moving in this area. In order to eventually make possible the coming out of the mixed substance, outlet openings 13 are brought in the wall which are placed on the whole twice on the periphery.

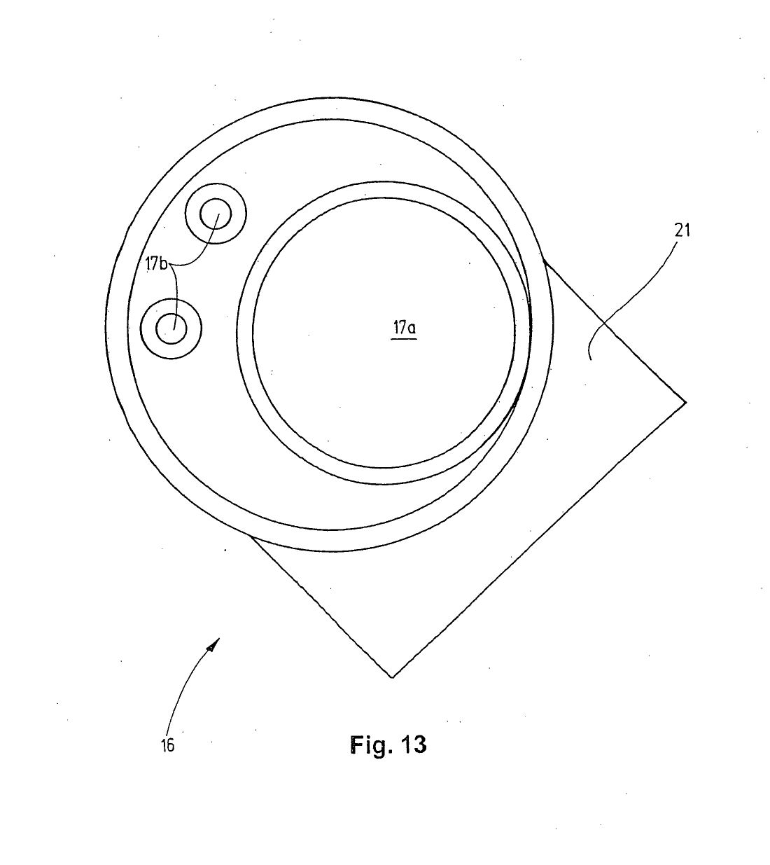

A top view of the stator part 16 which shows in particular the arrangement of the inlet openings 17a, 17b, 17′b is shown in FIG. 13. The inlet opening 17a is configured eccentric and has a circular cross section. Besides the inlet opening 17a, two inlet openings 17b, 17′b are provided in order to make possible a redundant feeding of the hardener component into the mixing chamber 14. This being, both inlet openings 17b, 17′b are configured spaced from each other and are fed by feeding lines which are also separated from each other and by metering devices 91, 92. Moreover, the arrangement of the delivery opening 21 which conveys the mixed substance laterally from the stator part 16 is also represented.

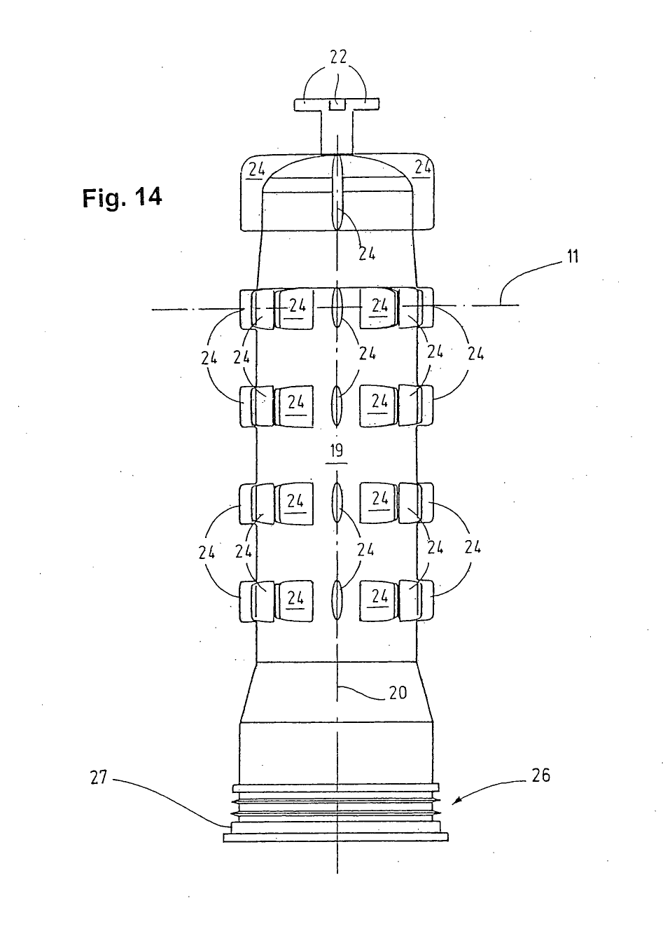

The rotor part 19 is represented in FIG. 14, whereby in particular the second mixing teeth 24 are represented with respect to their distribution on the periphery of the rotor part 19. On the whole twelve mixing teeth are provided on a mixing teeth surface plane 11 so that for on the whole four mixing teeth surface planes 11 on the whole 48 mixing teeth are placed on the rotor part 19. Additionally, four further mixing teeth 24 are placed on the upper part of the rotor part 19 for the preliminary mixing of the mixed substance. They change into the projections 22 which are also placed four times on a kind of extension of the rotor part 19.

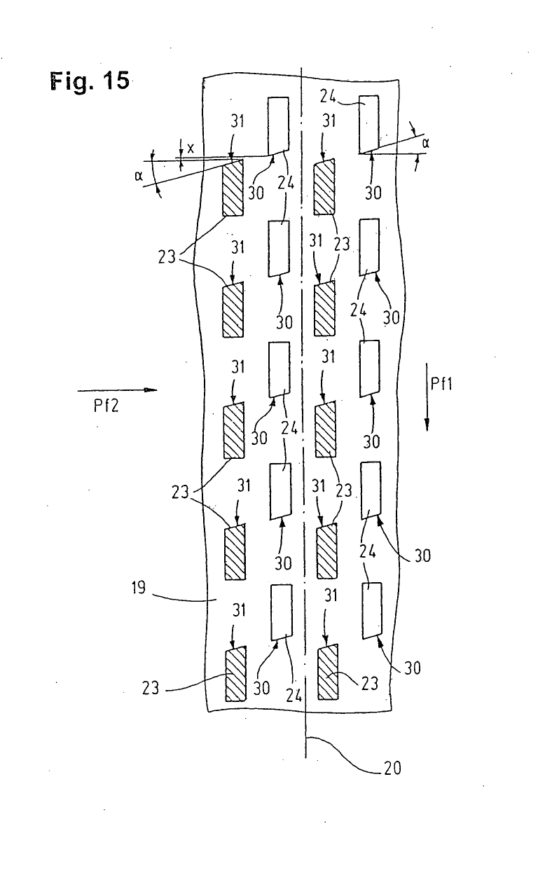

FIG. 15 illustrates a partial cross section through the mixing device 1 along the annular peripheral mixing area, whereby the mixing teeth 23 of the stator part 16 are represented hatched and the mixing teeth 24 of the rotor part 19 non hatched. The mixing teeth 23 and 24 of the single mixing teeth surface plantes are placed spaced from each other in such a manner that the teeth have tooth space to each other. The mixing teeth 23, 24 have intermediate spaces between the single mixing teeth surface planes, intermediate spaces through which the mixing teeth of the respectively other side which are opposite the concerned intermediate space during the rotational movement pass. Due to a continuous feeding of the components A, B into the mixing chamber 14, it comes to a division of the mixed substance flow, i.e. the mixed substance flows by respectively on the one side of the concerned tooth 23, 24 and the other part on the other side of the concerned tooth 23, 24. Since this division takes place in several stages corresponding to the number of the storeys or of the mixing teeth surface planes, the mixed substance is intensively blended.

The mixing teeth 23 have front side faces 31 which are opposite to the front side faces 30 which are moulded on the second mixing teeth 24. When the mixing teeth 23 touch the mixing teeth 24, a sliding off can take place without material being removed on the mixing teeth. This can take place in particular when the rotor part 19 is offset with respect to the stator part 16 about a value x so that the mixing teeth 23, 24 hit each other. The front side faces 30, 31 are chamferred by constituting an angle α, whereby the angle α is preferably 15°.

For the operation of the apparatus 100, it is proceeded according to the process technique in such a manner that the pistons 110, 111, 112 with the piston plates are placed manually by means of their piston rods 110, 111, 112 into the opened store tanks 90, 91, 92 and as soon as the piston plates come to bear below the edges of the opening of the store tanks 90, 91, 92, the motor 102 for the hydraulics is set into operation for actuating the piston rods 110, 111, 112 and only then the single mixing processes are carried out. Due to this measure, injuries are avoided which occur due to the fact that fingers of the hand of the operating person come to rest in the area of the edge of the opening, in particular of the store tank 90 for the binder component A and are pinched by the piston plate moved with a relatively high pressure in container direction.

While specific embodiments of the invention have been described in detail to illustrate the inventive principles, it will be understood that the invention may be embodied otherwise without departing from such principles.

I claim:

1. A device (100) for producing a ready-to-use filler for filling surfaces, the device comprising a mixing device (1) for blending at least two components, wherein the two components are a binder component (A) and a hardener component (B) to a pasty or liquid mixed substance. The mixing device (1) comprising at least one inlet opening (17a) for supplying the binder component (A) and at least one further inlet opening (17b; 17′b) for supplying the hardener component (B), and a delivery opening (21) for delivering out the mixed substance, wherein a mixing chamber (14) is located between the inlet openings (17a, 17b) and the delivery opening (21), the at least two components (A, B) being blended together in the mixing chamber with respectively one seat for a container (90, 91, 92) containing at least one component (A, B), wherein the seat has a surface in form of a carrying element (104), which has at least one opening (203) through which the component (A, B) can be delivered.

2. The device according to claim 1, wherein the carrying element (104) extends horizontally.

3. The device according to claim 1, wherein the inclination is 1° to 20°.

4. The device according to claim 1, wherein the inclination is 5° or 10°.

5. The device according to claim 1, wherein at least one sealing element (207, 317) is provided in the area of the opening (203).

6. The device according to claim 1, wherein the opening (203) is configured as a channel (206) projecting to the outside away from the carrying element (104).

7. The device according to claim 5, wherein a further arrangement element (208) is provided on the periphery to the channel (206), the element being provided between a channel projection and a sealing element (207).

8. The device according to claim 1, wherein the deepening and/or the projection are provided one of centrically, in the middle, eccentrically and offset to the middle (204).

9. The device according to claim 1, further comprising a pressure element (400) to be placed in the container for pressing out the component (A, B), the pressure element having which has a corresponding inclination for inclining the carrying element (104).

10. The device according to claim 1, wherein the mixing device (1) has a hollow cylindrical stator part (16) and a rotor part (19) lodged rotatable concentrically about a longitudinal axis (20) and the mixing chamber (14) is configured as an annular gap between the stator part (16) and the rotor part (19), wherein several first mixing teeth (23) molded on the stator part (16) extend radially inwards and several second mixing teeth (24) molded on the rotor part (19) extend radially outwards into the mixing chamber (14) for moving the mixing teeth (23, 24) against one another by a rotational movement of the rotor part (19) in the stator part (16) and for blending the two components (A, B), whereby the stator part (16) has an inlet opening (17b, 17′b) connected with the mixing chamber (14) for the hardener component (B) and the supply of the binder component (A) and of the hardener component (B) takes place by means of control devices to the mixing chamber (14) so that the hardener component (B) is fed with a slight advance or a preliminary injection with respect to the supply of the binder component (A) to the mixing chamber and whereby a quantity of 0.1 gram to 0.5 gram pasty or liquid hardener component (B) is injected into the mixing chamber (14) before or at the beginning of the continuous mixing process with the rotational movement of the mixing teeth (23, 24) running against one another.

11. The device according to claim 10, wherein the quantity of component (B) is 0.2 gram.

12. The device according to claim 9, wherein the stator part (16) carries at its end (16a) facing away from the inlet openings (17a, 17b, 17′b) an annular mounting (120) which has fixing openings (121) and which is removable like a bayonet catch and which is connected rotatable with the stator part (16), wherein the rotatability is limited by means of stoppers (122, 123; 122a, 123a) in such a way that a fit of the inlet opening (17a) for the binder component (A) is achieved with the feeding of the binder component A and simultaneously a fit of both inlet openings (17b, 17′b) for the hardener component (B) is achieved with the feedings of the hardener component B.

13. The device according to claim 10, wherein the annular mounting (120) has two slit-shaped opposite openings (125; 135) extending arc-shaped parallel to the peripheral edge of the mounting (120), each slit-shaped opening (125; 135) having two guiding sections (125a, 125b; 135a, 135b) with different widths, the respectively wider guiding section (125a; 135a) being configured to insert a L-shaped guiding cam (140; 140′) molded on the lower peripheral edge (16a) of the stator part (16), wherein the width of the wider guiding section (125a, 135a) corresponds to the length of the free bent-off leg (140a; 140′a) of the guiding cam (140; 140′) and the respectively narrower guiding section (125b; 135b) of which has a width which corresponds to the thickness of the leg (140b; 140′b) of the L-shaped guiding cam (140; 140′) which is molded on the lower peripheral edge (16a) of the stator part (16) and parallel to the longitudinal direction of the mixing device (1).

14. The device according to claim 10, wherein the wall area (125c; 135c) which is situated respectively on the outside of the narrower guiding section (125b; 135b) has web-type wall sections (125d; 135d) by configuring tongue-type edge areas (127, 137) with groove-type recesses, the depth of which corresponds approximately to the thickness of the bent-off leg (140a; 140′a) of the L-shaped guiding cam (140, 140′), wherein the number of the L-shaped guiding cams is higher than two L-shaped guiding cams.

15. The device according to claim 10, wherein the annular mounting (120) is made of a synthetic material or of metal.

16. The device according to claim 9, wherein the first mixing teeth (23) are placed on at least one first mixing teeth surface plane (10) and the second mixing teeth (24) on at least one second mixing teeth surface plane (11) and the mixing teeth surface planes (10, 11) are offset to each other axially in direction of the longitudinal axis (20) in the art of storeys so that the second mixing teeth (24) of the rotor part (19) rotate radially in the respective intermediate spaces of the first mixing teeth (23) of the stator part (16).

17. The device according to claim 11, wherein the mixing teeth (23, 24) have respectively front side faces (30, 31) which are turned respectively to each other in axial direction in order to position them against each other for an axially acting force between the stator part (16) and the rotor part (19).

18. The device according to claim 17, wherein the front side surfaces (30, 31) are inclined with respect to a surface plane placed normally to the rotational axis under an angle (a) so that the front side surfaces (30, 31) slide off onto each other during the mixing procedure without material being removed from the mixing teeth (23, 24) and coming into the mixed substance.

19. The device according to claim 11, wherein the inlet openings (17a, 17b) run directly into the mixing chamber (14), whereby the inlet opening (17b) is provided twice for feeding the hardener component (B) in order to create a redundant supply of the mixed substance with the hardener component (B).

20. The device according to claim 11, wherein the rotor part (19) has on the end side projections (22) which penetrate into the inlet opening (17a) for feeding the binder component (A) and rotate together with the rotation of the rotor part (19) in order to reduce the thixotropy of the binder component (A) already in the supplying channel of the inlet opening (17a).

21. The device according to claim 11, wherein the rotor part (19) has an end-sided open recess (29) as a hollow cylinder into which a core with adapted geometry can be inserted by means of which the rotor part (19) can be driven.

22. The device according to claim 21, wherein the recess (29) comprises snap-in ribs (25) extending radially inwards from the body of the rotor part (19) which snap-in into corresponding sparings in the core in order to transfer the driving torque for the operation of the mixing device (1) from the rotationally driven core to the rotor part (19).

23. The device according to claim 11, wherein the rotor part (19) has sealing lips (26) for to sealing the mixing chamber (14) between the rotor part (19) and the stator part (16) and for preventing a discharge of the mixed substance.

24. The device according to claim 11, wherein the stator part (16) has at least one plate-shaped moulding (18) on the outer periphery, whereby at least one plate-shaped moulding (18) comprises a crescent-shaped snap-in contour (15) into which at the start of the mixing device (1) a pin element catches in order to secure the radial position of the delivery opening (21) in the stator part (16).

25. Device according to claim 11, wherein the rotor part (19) has a cylindrical bearing section (27) in order to create a slide bearing arrangement in the stator part (16) for the radial bearing.

26. Device according to claim 11, wherein the stator part (16) comprises a supporting bearing surface (12) on which the rotor part (19) bears on the front side with mixing teeth (24) moulded thereon and slides off in order to create an axial slide bearing arrangement.

27. Device according to claim 23, wherein a hollow space (28) is configured between the sealing lips (26) in order to make possible to collect the mixed substance passing through the sealing lips (26).

28. The device according to claim 27, wherein the stator part (16) has at least one outlet opening (13) in the cylindrical section of the hollow space (28) on the peripheral side in order to avoid the coming out of the mixed substance from the cylindrical bearing section (27).

29. The device according to claim 11, wherein at least the stator part (16) is of a transparent material, wherein the transparent material is made from the group of the plastics comprising a polycarbonate (PC), a polymethylmetacrylate (PMMA) and a styrene-acrylnitrile (SAN).

30. Container for at least one component for producing a filler for filling surfaces with at least one base surface (302) and at least one lateral surface (301), wherein the base surface (302) has an opening (313) for delivering the component (A, b), and the base surface (302) has a shape which corresponds to the shape of the carrying element (104) such that the container (90, 91, 92) can be set onto the carrying element (104) in such a manner that a safe stand on the carrying element (104) is given.

31. Container according to claim 30, wherein the lateral surface (301) is connected with a Wymer seam.

32. Container according to claim 30, wherein the base surface is placed with respect to the lateral surface (301) in such a manner that projections (315, 318) or the lowest part of the base surface do not project over the end of the lateral surface (301) which is turned to the base surface.

33. Container according to claim 30, wherein a sliding element (303) which has preferably a corresponding inclination to the inclination of the base surface (302) is provided under an upper cover (304) of the container (90, 91, 92).

34. Container according to claim 30, wherein a sealing element (317) is provided in the area of the delivery opening (313) on the lower side (311) of the base surface (302).

35. A system comprising a device for producing a ready-to-use filler for filling surfaces, the device comprising a mixing device (1) for blending at least two components, wherein the two components are a binder component (A) and a hardener component (B) to a pasty or liquid mixed substance. The mixing device (1) comprising at least one inlet opening (17a) for supplying the binder component (A) and at least one further inlet opening (17b; 17′b) for supplying the hardener component (B), and a delivery opening (21) for delivering out the mixed substance, wherein a mixing chamber (14) is located between the inlet openings (17a, 17b) and the delivery opening (21), the at least two components (A, B) being blended together in the mixing chamber with respectively one seat for a container (90, 91, 92) containing at least one component (A, B), wherein the seat has a surface in form of a carrying element (104), which has at least one opening (203) through which the component (A, B) can be delivered, and of a container for at least one component for producing a filler for filling surfaces with at least one base surface (302) and at least one lateral surface (301), wherein the base surface (302) has an opening (313) for delivering the component (A, b), and the base surface (302) has a shape which corresponds to the shape of the carrying element (104) such that the container (90, 91, 92) can be set onto the carrying element (104) in such a manner that a safe stand on the carrying element (104) is given.
